(19) United States
(12) Patent Application Publication
(10) Pub. No.: US 2007/0254637 A1
(43) Pub. Date: Nov. 1, 2007

(54) Device, Method and Computer Program Product Readable Medium for Establishing a Communication Session

(76) Inventors: Laurence Plant, North Balwyn (AU); Pnina Vortman, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/381,003

(22) Filed: May 1, 2006

(51) Int. Cl. H04M 3/00

(52) U.S. Cl. 455/418

(57) ABSTRACT

A method for establishing a communication session, the method includes: receiving a request to establish a communication session with a certain user out of a group of users that are allowed to share a group of communication devices and responding to the request in response to presence information associated with the certain user. A system adapted to establish a communication session, the system includes: an interface adapted to receive a request to establish a communication session with a certain user out of a group of users that are allowed to share a group of communication devices; and a controller adapted to respond to the request in response to presence information associated with the certain user.

### FIELD OF THE INVENTION

The present invention relates to methods, devices and computer program products for establishing a communication session.

### BACKGROUND OF THE INVENTION

The cost of communication devices such as but not limited to cellular phones is relatively high. Many potential users do not purchase a telecommunication device due to its cost. Accordingly, even if a wireless infrastructure is present, many people cannot be reached by using modern telecommunication methods.

A cellular phone is associated with a single user. This single user can configure the cellular phone according to his preferences, and is also charged for various operations (such as outgoing calls, downloading content and the like) that are executed by the single user.

Various companies, factories and mining facilities need to track after their workers. Various methods and devices for establishing communication sessions with the workers are based upon the provision of dedicated communication devices to each worker.

There is a need to provide efficient devices, methods and computer program products for establishing communication sessions.

### SUMMARY OF THE PRESENT INVENTION

Method, device and computer program product for establishing a communication session.

Conveniently the method includes: receiving a request to establish a communication session with a certain user out of a group of users that are allowed to share a group of communication devices; responding to the request in response to presence information associated with the certain user.

In accordance with another embodiment of the present invention, a method for establishing a communication session is provided. The method includes receiving, at a communication device out of a group of communication devices that are adapted to be used by a group of users, a notification that a system approved a request to establish a communication session with a certain user, wherein the approval is responsive to presence information associated with the certain user, receiving a response from the certain user, and providing the response to the system.

In accordance with another embodiment of the present invention, a system adapted to establish a communication session is provided. The system includes an interface adapted to receive a request to establish a communication session with a certain user out of a group of users that are allowed to share a group of communication devices, and a controller adapted to respond to the request in response to presence information associated with the certain user.

### BRIEF DESCRIPTION OF THE DRAWINGS

The present invention will be understood and appreciated more fully from the following detailed description taken in conjunction with the drawings in which:

FIG. 1 illustrates a multi-user environment according to an embodiment of the invention;

FIG. 2 illustrates a login session, according to an embodiment of the invention;

FIG. 3 illustrates a phone call sequence according to an embodiment of the invention;

FIG. 4 illustrates a phone call sequence according to an embodiment of the invention;

FIG. 5 illustrates a method for establishing a communication session, according to an embodiment of the invention; and

FIG. 6 illustrates a method for establishing a communication session, according to another embodiment of the invention.

### DETAILED DESCRIPTION OF THE DRAWINGS

Methods, devices and computer program products are provided.

These methods, devices and computer readable programs enable multiple users (a group of users) to share multiple communication device (a group of one or more communication devices).

For example, multiple users can share a group of mobile phones. Each user can have his own virtual phone number. A user can log on to a certain mobile phone, and presence information that associates between the certain mobile phone and the certain (logged on) user is generated.

If another person wishes to establish a call with that certain user this other person will dial the virtual phone number, and in response to the association between the phone number of the certain mobile phone and the virtual phone number of the user, the call will be directed to that certain mobile phone. Conveniently, the virtual phone number (or another indication representative of the certain user) will be displayed on the display of the certain mobile phone to indicate the intended called part.

It is noted that billing entities can be instructed to generate zero charge records for the mobile phones and generate billing records associated with the virtual phone number.

According to an embodiment of the invention the presence information can include user profile information. Conveniently, the user profile information can describe the company that hires the user, the role of the user, the skills of the user, the type of work of the user, his hobbies, and the like. The user profile information can be updated in various manners but is usually static in nature.

According to an embodiment of the invention a call can be routed in response to a virtual phone number as well as the user profile information. For example, multiple users can have the same virtual phone but differ from each other by their user profile information. When a user dials that virtual phone number he may be asked to provide user profile information. If, for example a user dials a virtual phone number and only one out of multiple users that share that virtual phone number is available than the call can be routed to that user. Conveniently, various filtering operations can be based upon user profile information.

Conveniently, the communication devices can be shared between various groups of users. For example, employees of a certain company, factory or mine can use a group of communication devices. The communication devices can be used within a certain facility. Thus, when a certain worker replaces another worker the shared communication device can be given to the certain worker. In such a case the communication device can monitor the presence of the workers. It can also include health sensors that can track after the vital signs of the worker. The monitoring can include determining the when a worker started a shift and that worker ended the shift, in response to the usage of the communication device by that worker.

According to an embodiment of the invention a virtual phone number can be assigned to a group of users. Once that virtual phone number is dialed the call will be directed to an available member of the group. If more than one member of the group is available predefined selection rules can be applied. It is noted that the members of this group can also have their own virtual phone number but this is not necessarily so. A group of users that are assigned with the same virtual phone number can include emergency service providers such as policemen, fire fighters, paramedics, and the like.

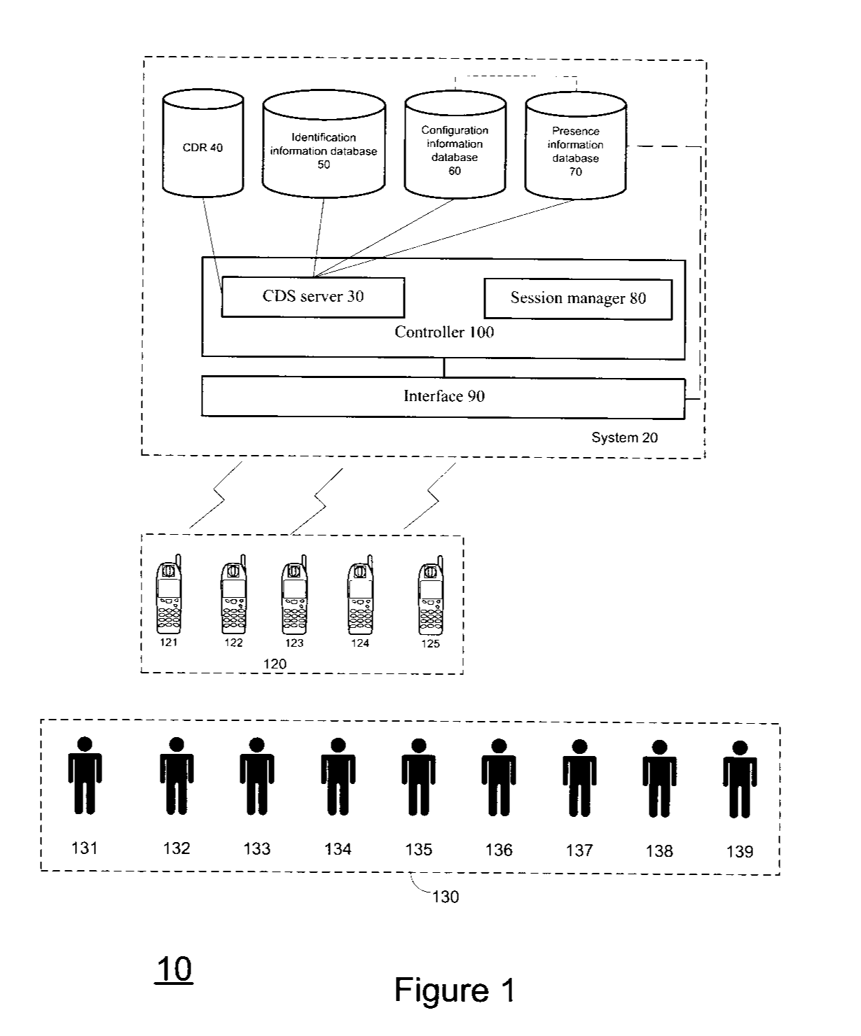

FIG. 1 illustrates a multi-user environment 10 according to an embodiment of the invention.

For simplicity of explanation FIGS. 1-4 illustrate a communication session that is a phone call and communication devices that are mobile phones. It is noted that the communication session can include data exchange sessions, instant messaging chat sessions, video-conferences, and the like. The communication devices can be connected to each other over wireless networks, wired networks, satellite networks, terrestrial networks, a combination of one or more networks and the like. For example, the communication devices can communicate within each other using an under-ground array of wireless and/or wired transceivers, nodes or routers.

It is further noted that each communication device can support multiple communication sessions concurrently, and especially different types of communication sessions.

A certain communication device can exchange signals with one or more networks, using various communication protocols.

Multi-user environment 10 includes system 20 as well as a group 120 of communication devices. The group of communication devices 120 includes multiple communication devices such as cellular phones 121-125. Conveniently, at any given moment one or more communication devices of group 120 can be activated.

Each communication devices out of group 120 can be used by user out of group of users 130. Group of users 130 includes people 131-139.

It is noted that the number of users within group 130 usually exceeds and even well exceeds the number of communication devices of group 120.

It is noted that the number of users that belong to a single group of users can differ than nine, that the number of communication devices can differ than five and that a certain person can belong to multiple groups of users.

A person is usually required to perform a registration process in order to be regarded as a user. This registration process may include at least one of the following stages: (i) receiving billing related information of that person (for example credit card number, bank account), (ii) assigning authentication information (such as password, username and the like) to the person, and (iii) assigning a user identifier (such as a virtual phone number) to that person. The user identifier is used when another person wishes to establish a communication session with the user.

The user can configure a communication device such that when he uses that communication device he can use predefined application, access previously stored data and the like. The configuration information is also referred to as communication device application information as it can define applications that can be executed by the communication device, and can include data that is used by these applications such as phone numbers, diaries, the displays that will be displayed to the user, sounds that will be generated by the device and the like. The configuration information is stored at system 20 and sent to the communication device when the user uses the communication device.

Conveniently, the configuration information can be stored in a secured manner in the system, stored in an encrypted manner in the communication device and the like.

System 20 includes an interface 90, a controller 100 and one or more databases 40-70. It is noted that system 20 can include additional or other database, that system 20 can have different configurations, and can include other components than those illustrated in FIG. 1.

The interface can include a receiver, a transmitter, various data links and the like.

The functionality of these different components will be further illustrated below. Controller 100 conveniently includes a communication device sharing (CDS) server 30 and a session manager 80.

Each communication device out of group 130 includes an interface for receiving and transmitting information as well as a controller that controls the operation of the communication device. FIG. 1 illustrates mobile phones that include a wireless interface that includes a receiver and well as a transmitter for transmitting and receiving signals over a wireless network. The interface can also include the keyboard of the mobile phones, as well as its display. The controller includes one or more integrated circuits within the mobile phone.

The controller conveniently executes a dedicated code that enables it to exchange information with system 20, and especially with CDS server 30.

A typical communication device can be a fixed or a mobile handset, typically a second generation compliant or higher generation compliant mobile phone.

CDS Server 30 is adapted to authenticate users, determine whether to update presence information related to one or more users, decide how to respond to requests to establish communication sessions with a user, and control the reception of and transmission of user configuration information.

According to an embodiment of the invention system 20 is adapted to receive presence information from users, update a presence information database 70, and in response to the presence information determine whether to direct an entering phone call to a voice mail, direct an entering call to a communication device on which the user is logged on, and the like.

It is noted that the presence information can be responsive to the identity of the calling party that initiates the phone call. For example, a certain user can define certain call routing rules to a certain requester and define other call routing rules to another requester. Yet for another example, the certain user can display a first type of presence message to a first requester while displaying another type of presence information to another requester.

According to an embodiment of the invention the controller 100 is adapted to update one or more potential requesters with presence information relating to one or more user. System 20 can broadcast this information, can perform unicast transmissions and the like.

Updated presence information can be sent to one or more persons (or more accurately to devices accessed by persons), in various manners including periodical updates, random or semi-random updates, transmission in response to an occurrence of events such as an addition of an new user, an occurrence of a log off session, and the like. The presence information can be transmitted to some persons and not to other persons.

The update can be responsive to various update rules, and/or to update parameters such as network load, update significance and the like. The update rules can be determines by users, by a system operator, by a system administrator and the like.

Presence information can be sent to various persons before they send a request to initiate a communication session with a user. The presence information can indicate which users can participate in the communication session, thus allowing a requester to consider whether to initiate a communication session.

The updated presence information and optionally older versions of the presence information can be stored in presence database 70. The presence information can indicate the status of users and/or communication devices. For example this information can indicate whether the user is logged on to communication device, what is that communication device, whether the user is participating in another communication session, whether the user can receive new communication sessions, whether a communication device is active and the like.

It is noted that the presence information database 70 can receive presence information from various sources including but not limited to: (i) other databases (for example—receiving information from identification information database 50), (ii) a cellular network (for example—receiving information that indicates if the communication device of the user is accessible by the cellular network, receiving information that indicates if the user is participating in another phone call, receiving location information representative of the location of the user, and the like), (iii) the communication device of that user (for example receiving health related information, receiving updates to the user profile information via the communication device, or receiving information that the device is in a car—meaning the user is driving), and the like. The location information can indicate its logical or physical location. A logical location can be derived from the physical location as well as additional information (for example using additional information derived from an additional mapping database) Logical location can be, for example, “home”, “office”, “car”, “Emergency Room”, Operation room”, “Level 3 of the Mine”, and the like.

The dashed lines that connect the presence database 70 to the identification database 50 and to interface 90 illustrate some possible presence information providers.

System 20 also includes a user authentication database 50 that stores identification information. This information is used to authenticate and authorize users.

User configuration information is stored in the user configuration database 60. This configuration information can include application related information, address book, messages and the like.

Session manager 80 is adapted to establish and maintain the communication sessions between persons. The session manager 80 can interface with different networks and network controlling or management entities. The session manager 30 can be an integral part of system 20, can partially belong to system 20 and the like. For example, the session manager 80 can interface to a third party call control API available on a Parlay-X Gateway, thereby requesting another external network set up the call.

Conveniently, session manager 80 can interface to any platforms, components or devices that enable to connect different persons. The various components and protocols may include: (i) next generation soft switches that support Voice Over Internet Protocol packet connectivity between parties; (ii) protocols for interfacing with such soft switches such as SIP, MEGACO, H.323, (iii) abstracted interfaces such as Parlay-X, (iv) current generation switches providing E1 or similar circuit switched voice connectivity between parties, (v) protocols for interfacing to current generation switches for call control such as SS7 and abstracted interfaces such as Parlay-X, (vi) instant messaging servers providing the ability for users to share text messages in a chat session; (vii) interfaces to IM Servers include SIMPLE and vendor-specific protocols.

According to an embodiment of the invention the CDS server 30 is also connected to billing entities such as pre-paid billing entities, post paid billing entities and the like.

FIG. 1 illustrates a billing entity that is referred to as CDR 40. CDR 40 generates call detail records for billing purposes. The CDR 40 is adapted to associate call detail records with the user (for example with his virtual phone number) and not necessarily with the communication device the user uses.

For simplicity of explanation a user that belongs to the group of users that can share the communication devices is referred to as a CDS user and the communication devices that belong to the group of communication devices are referred to as CDS handsets.

According to various embodiments of the invention a CDS user can provide to system 20 configuration information, identification information and even presence information using devices that differ from the CDR communication device. This information can be provided over other links than the virtual links between system 20 and the CDS communication device illustrated in FIG. 1. For example, a CDS user can use the Internet to register itself as a CODS user, can use various types of secured connection to provide identification information and/or billing related information. Yet for another example, a CDS user can use a non-CDS communication device (such as a mobile phone that is not shared by a group of users, a wired phone and the like) to request to update his presence information distribution rules, and the like.

Yet for another embodiment of the invention a CDS user can use a first CDS communication device for participating in a first type of communication session and also use (even concurrently) another CDS communication device for participating in another type of communication sessions.

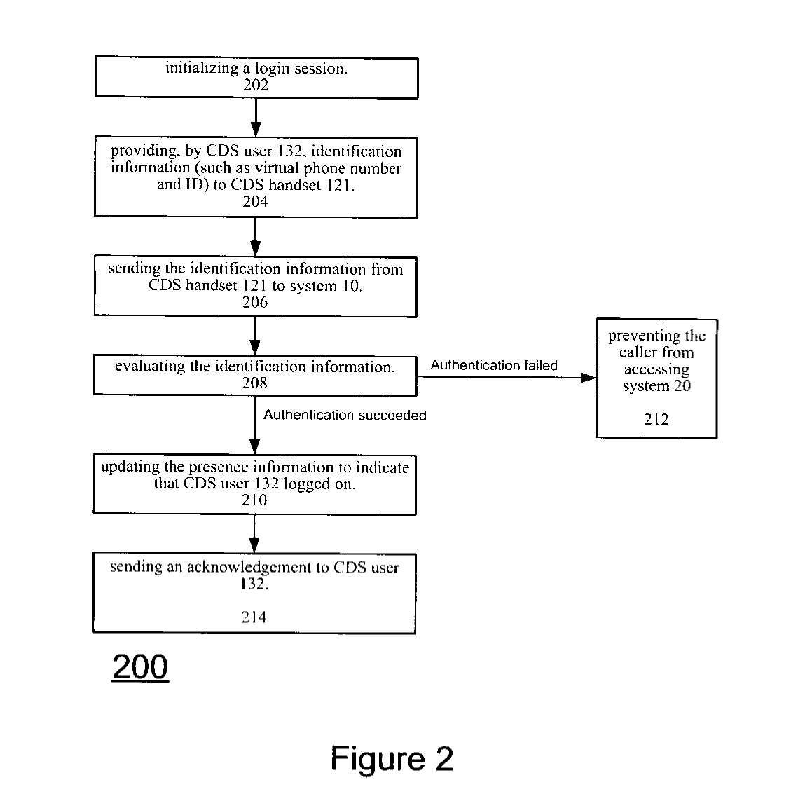

FIG. 2 illustrates a login session 200, according to an embodiment of the invention.

During the login session a CDS user such as CDS user 132 is authenticated and his presence information is updated. After the logic session 200 is completed CDS user 132 can receive phone calls to its virtual phone number by using a CDS handset such as CDS handset 121.

Login session 200 starts by stage 202 of initializing a login session. This can include pressing a certain button, selecting a certain menu, generating a vocal instruction and the like.

Stage 202 is followed by stage 204 of providing, by CDS user 132, identification information (such as virtual phone number and ID) to CDS handset 121.

Stage 204 is followed by stage 206 of sending the identification information from CDS handset 121 to system 10.

Stage 206 is followed by stage 208 of evaluating the identification information. This stage can include comparing the received identification information to the identification information stored in identification database 50 and determining if a legitimate user tries to login.

The comparison can be executed by CDS server 30. It is noted that the identification information can be evaluated in different manners. For example, the received identification information can be further processed during the evaluation.

If the answer is positive (the CDS user is a valid CDS user) stage 208 is followed by stage 212, else it if followed by stage 210.

Stage 210 includes updating the presence information to indicate that CDS user 132 logged on. Conveniently, stage 210 includes creating a new record in presence database 70 that indicates that CDS user 132 is using CDS 121.

Stage 210 can be followed by stage 214 of sending an acknowledgement to CDS user 132.

Stage 212 includes preventing the caller from accessing system 20, requesting the user to provide new identification information, sending a notification to security management entity, and the like.

It is noted that a CDS user can update its presence information and especially update presence information transmission rules during the login session or after the login session. The presence information transmission rules can define how the presence information is sent to other persons, determine the presence information to be sent to certain persons, and the like.

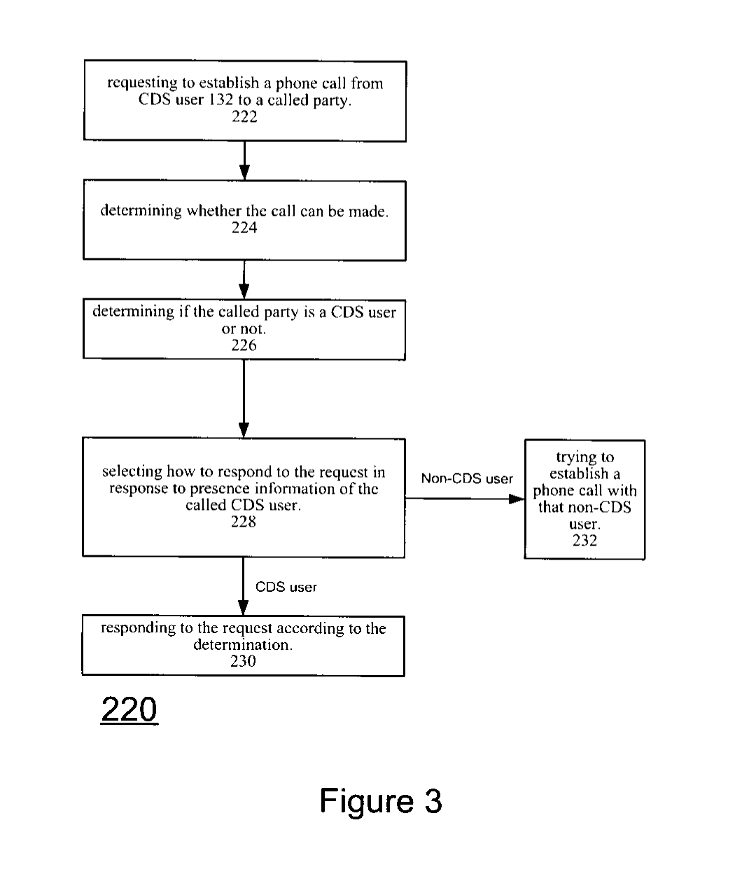

FIG. 3 illustrates a phone call sequence 220 according to an embodiment of the invention.

The calling party is a CDS user while the called party can be a CDS user or a non-CDS user. It is assumed that the calling party is CDS user 132. Sequence 220 starts while CDS user 132 is logged on to CDS phone 121.

Sequence 220 starts by stage 222 of requesting to establish a phone call from CDS user 132 to a called party. Stage 222 may include identifying CDS user 132 and providing the phone number (can be a virtual phone number of a CODS user) of the called party.

Stage 222 can include receiving from CDS user 132 the number of the called party or retrieving this number from a previously stored file. Thus, the CDS phone 121 can display various menus that include the names of other parties and the calling party can indicate to which called party it wishes to call.

According to an embodiment of the invention stage 222 can include displaying to the calling party presence information representative of the accessibility of other parties. The calling party can decide not to call an un-accessible party, or to leave to the un-accessible party a voice message, a text message or an audio-visual message.

Stage 222 is followed by stage 224 of determining whether the call can be made. Stage 224 can include authenticating the calling party, determining whether the authenticated calling party can initiate a call and whether the calling party can call the called party.

It is noted that various limitations can be imposed on the phone calls that are made by the calling party. For example, the credit of the calling party can be examined during stage 224, especially of the calling party is a pre-paid user.

Yet for another example, the calling party can access only local called parties, and the like. Parents can prevent their children from calling various services, and the like.

If the call cannot be made stage 224 is followed by stage 240 of denying the call. Stage 240 can include sending a notification to the calling party or to another party.

Assuming that the call can be made stage 224 is followed by stage 226 of determining if the called party is a CDS party or not.

If the called party is a CDS user (for example CDS user 138) stage 226 is followed by stage 228 of selecting how to respond to the request in response to presence information of the called CDS user.

According to an embodiment of the invention stage 228 can be responsive to the user profile information. According to yet a further embodiment of the invention the called party can include a group of CDS users that are assigned the same number. The routing of the call is responsive to the presence information of the members of that group, and also can be responsive to selection rules between available members of that group.

Stage 228 is followed by stage 230 of responding to the request according to the determination. Stage 230 may include requesting the called party (CDS user 138) to authenticate before allowing it to talk with calling party (CDS user 132).

For example, if CDS user 138 logged to CDS phone 125 the call can be directed to CDS phone 125 and not to other CDS phones of group 120. Yet for another example, if CDS user 138 defined that it wishes to direct phone calls from CDS user 132 to its voice mail then the phone call will be directed to the voice mail of CDS user 138. Yet for a further example, if the presence information indicates that CDS user 138 is not accessible then the phone call can be terminated, CDS user 132 can receive an indication that CDS user 138 is not available, the call can be directed to the voice mail of CDS user 138 and the like.

Conveniently, the called party can receive information that describes the calling party, the virtual phone number of the called party, and the like. The calling party can also prevent the called party from viewing his phone number. This can be made by defining a rule that is applied when the calling party calls a certain called party. Such a rule is usually stored at the configuration database 60.

If the called party is a non-CDS user then stage 226 is followed by stage 232 of trying to establish a phone call with that non-CDS user. It is noted that even non-CDS users can be available, not available, can direct incoming phone calls to their voice mail, and the like. In addition, the calling party can define which information should be provided to the called party. The called party can see the virtual phone number of the calling party, the name of the calling party, a symbol that represents the calling party and the like.

It is noted that any stage of stages 230 or 232 can include interfacing with various communication networks, and utilizing session manager 80. For example, the session manager 80 can (directly or indirectly) alert the called party that of the incoming call. Session manager 80 can send to the called party an indication that CDS user 132 made the call but this is not necessarily so.

Either one of stage 230 and 232 can include generating a log of the call between CDS user 132 and the called party.

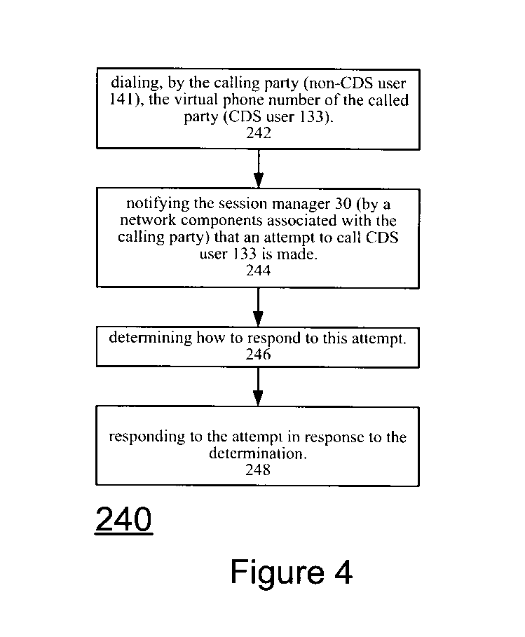

FIG. 4 illustrates a phone call sequence 240 according to an embodiment of the invention.

It is assumed that the calling party is non-CDS user 141 and that the called party is CDS user 133. Sequence 220 starts while CDS user 133 is logged on to CDS phone 123.

Sequence 240 starts by stage 242 of dialing, by the calling party (non-CDS user 141), the virtual phone number of the called party (CDS user 133).

Stage 242 is followed by stage 244 of notifying the session manager 30 (by a network components associated with the calling party) that an attempt to call CDS user 133 is made.

Stage 244 is followed by stage 246 of determining how to respond to this attempt. Stage 246 can include retrieving presence information relating to the called party (CDS user 133), determining to which CDS phone to route the phone call, determining to reject the attempt or routing the calling user to the voice mail of the called party. As mentioned above the presence information can also be associated with the calling party, as the called party can define different rules to different calling parties.

Stage 246 is followed by stage 248 of responding to the attempt in response to the determination.

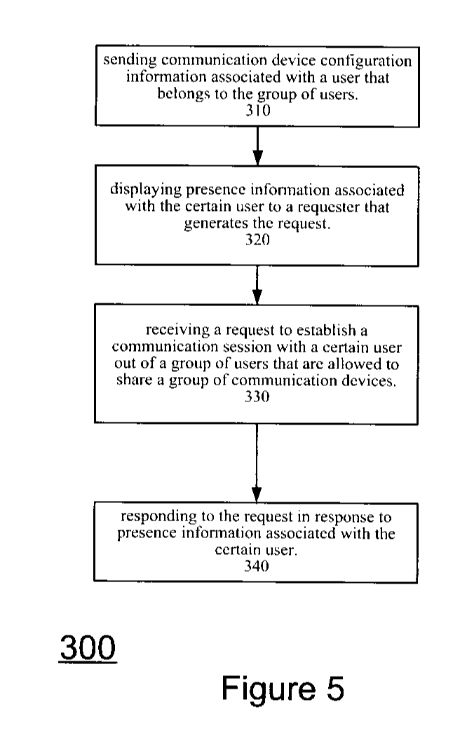

FIG. 5 illustrates a method 300 for establishing a communication session, according to an embodiment of the invention.

Method 300 starts by stage 310 of sending communication device configuration information associated with a user that belongs to the group of users. Conveniently this information is sent when the user logs on to the device. When another user of the group logs to that same device or otherwise used the device the configuration information of the other user is not presented or accessible to that other user.

Stage 310 is followed by stage 320 of displaying presence information associated with the certain user to a requester that generates the request. Conveniently, stage 320 includes displaying, to a requester of a communication session, presence information associated with various users and with the requester. In other words, a user can define which presence information is displayed to which person. For example, a user can request to be available to some persons while be non-available to others. Thus, if certain persons call this user the call can be rejected.

Conveniently, stage 320 is followed by stage 330 of receiving a request to establish a communication session with a certain user out of a group of users that are allowed to share a group of communication devices.

Stage 330 is followed by stage 340 of responding to the request in response to presence information associated with the certain user.

Conveniently, stage 340 of responding includes selecting a communication device out of the group of communication devices in response to the presence information associated with the certain user.

Conveniently, stage 340 includes requesting the certain user to authenticate before establishing the communication session with the user.

Conveniently, stage 340 includes billing the certain user.

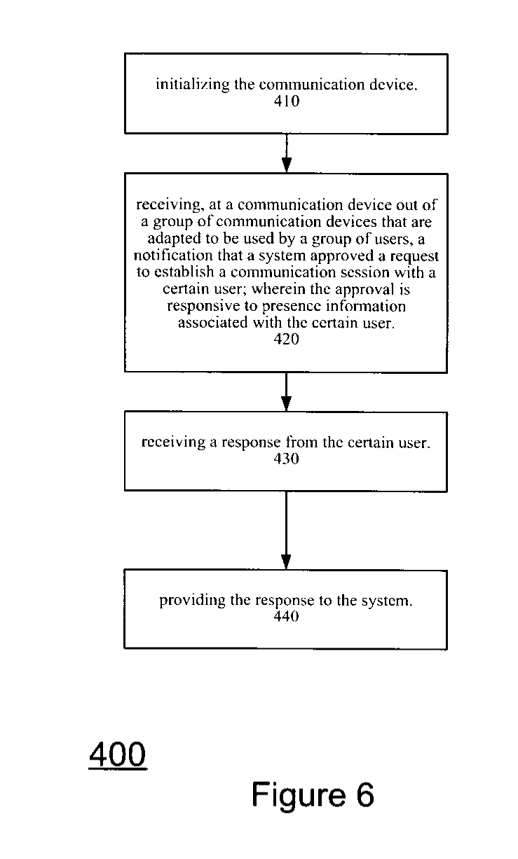

FIG. 6 illustrates a method 400 for establishing a communication session, according to another embodiment of the invention.

Method 400 starts by stage 410 of initializing the communication device. Stage 410 can include logging on, authenticating a user, requesting from a system to receive configuration information associated with a logged on user, receiving the configuration information and configuring the communication device according to configuration information associated with a certain user that logs on.

Stage 410 is followed by stage 420 of receiving, at a communication device out of a group of communication devices that are adapted to be used by a group of users, a notification that a system approved a request to establish a communication session with a certain user; wherein the approval is responsive to presence information associated with the certain user.

Stage 420 is followed by stage 430 of receiving a response from the certain user.

Stage 430 is followed by stage 440 of providing the response to the system.

According to various embodiments of the invention each of the mentioned above methods and sessions can include at least one of the following stages: (i) Updating presence information. The update can reflect that a CDS user has logged off. A request to log off can update various log records, require the logging off CDS user to authenticate and the like. (ii) Adding a new CDS communication device to the group of CDS devices, removing a CDS communication device from a group of CDS devices and the like. (iii) Adding a new CDS user to a group of CDS users, removing a CDS user from the group and the like. (iv) Caching data at a CDS communication device, (v) Deleting information from the CDS communication device once a user logs off. This may include configuration information, logs of number dialed, log of calls made by the user, and the like.

According to various embodiments of the invention multiple systems such as system 20 can exchange information with each other. The different systems can be of the same type, but this is not necessarily so. A central system such as system 20 can interface with or otherwise exchange information with one or more local systems such as 20.

According to various embodiments of the invention system 20 can interface with multiple networks.

Yet according to another embodiment of the invention a system such as system 20 can be shared by employees of a certain enterprise, while being secured from access of outsiders.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, the computer program product includes a computer useable medium including a computer readable program, wherein the computer readable program when executed on a computer causes the computer to execute at least one stages of at least one method out of methods and sequences mentioned above.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method for establishing a communication session, the method comprising:
receiving a request to establish a communication session with a certain user out of a group of users that are allowed to share a group of communication devices; and
responding to the request in response to presence information associated with the certain user.

2. The method according to claim 1 wherein the responding comprises selecting a communication device out of the group of communication devices in response to the presence information associated with the certain user.

3. The method according to claim 1 further comprising sending to a communication device configuration information associated with a user that belongs to the group of users.

4. The method according to claim 1 wherein the responding comprises requesting the certain user to authenticate before establishing the communication session with the user.

5. The method according to claim 1 wherein the receiving is preceded by displaying presence information associated with the certain user to a requester that generates the request.

6. The method according to claim 1 wherein the receiving is preceded by displaying presence information associated with the certain user and with a requester that generates the request.

7. The method according to claim 1 further comprising billing the certain user.

8. The method according to claim 1 further comprising concealing selected communication device information from a requester that requested to establish the communication session.

9. The method according to claim 1 further comprising sending presence information to at least one potential requester.

10. A method for establishing a communication session, the method comprises:
receiving, at a communication device out of a group of communication devices that are adapted to be used by a group of users, a notification that a system approved a request to establish a communication session with a certain user, wherein the approval is responsive to presence information associated with the certain user;
receiving a response from the certain user; and
providing the response to the system.

11. The method according to claim 11 further comprising configuring the communication device according to configuration information associated with the certain user.

12. The method according to claim 11 further comprising receiving the configuration information from the system.

13. The method according to claim 11 further comprising receiving authentication information from the certain user.

14. A system adapted to establish a communication session, the system comprises:
an interface adapted to receive a request to establish a communication session with a certain user out of a group of users that are allowed to share a group of communication devices; and
a controller adapted to respond to the request in response to presence information associated with the certain user.

15. The system according to claim 15 wherein the controller is adapted to select a communication device out of the group of communication devices in response to the presence information associated with the certain user.

16. The system according to claim 16 further adapted to send to the selected configuration information associated with the certain user.

17. The system according to claim 16 wherein the system is adapted to request the certain user to authenticate before establishing the communication session with the user.

18. The system according to claim 16 wherein is adapted to send presence information associated with the certain user to a requester that generates the request.

19. The system according to claim 16 further adapted to bill the certain user.

20. The system according to claim 14 wherein the presence information comprises user profile information.
